(19) United States
(12) Patent Application Publication
(10) Pub. No.: US 2014/0280290 A1
(43) Pub. Date: Sep. 18, 2014

(54) SELECTION AND DISPLAY OF ALTERNATIVE SUGGESTED SUB-STRINGS IN A QUERY

(71) Applicant: MICROSOFT CORPORATION, Redmond, WA (US)

(72) Inventors: Patrick J. Baumgartner, Kirkland, WA (US); Amir Netz, Bellevue, WA (US); Pedram Faghihi Rezaei, Seattle, WA (US); Christopher Alan Hays, Monroe, WA (US); Cristian Petculescu, Seattle, WA (US)

(73) Assignee: Microsoft Corporation, Redmond, WA (US)

(21) Appl. No.: 13/804,715

(22) Filed: Mar. 14, 2013

(51) Int. Cl. G06F 17/30

(52) U.S. Cl. CPC G06F 17/3097
USPC 707/767

(57) ABSTRACT

Suggesting replacements for search sub-strings to a user. A method includes receiving a query string from a user including a plurality of search sub-strings in the query string. The method further includes determining semantically valid replacements of one or more search sub-strings in the query string. The method further includes suggesting to the user semantically valid replacements of one or more of the search sub-strings to allow the user to modify the original query string.

### BACKGROUND

### Background and Relevant Art

Computers and computing systems have affected nearly every aspect of modern living. Computers are generally involved in work, recreation, healthcare, transportation, entertainment, household management, etc.

When conducting a search using common user experiences for search, a user is typically provided a variety of supporting features to help them determine how to express their query in the form of a text string. For example, while the user types, relevant characters or words, such as those previously searched for by other users, may be automatically appended to the text they are typing. However, even with suggested search sub-strings, it may be difficult for users to construct relevant searches as the users may not be able to independently arrive at important variations of input search sub-strings, or to know search sub-strings that may yield different, but interesting results.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for suggesting replacements for search sub-strings to a user. The method includes receiving a query string from a user including a plurality of search sub-strings in the query string. The method further includes determining semantically valid replacements of one or more search sub-strings in the query string. The method further includes suggesting to the user semantically valid replacements of one or more of the search sub-strings to allow the user to modify the original query string.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a view of a user interface for receiving a user query and providing suggestions to the user for replacements of elements of the query;

FIG. 2 illustrates another view of a user interface for receiving a user query and providing suggestions to the user for replacements of elements of the query;

FIG. 3 illustrates another view of a user interface for receiving a user query and providing suggestions to the user for replacements of elements of the query;

FIG. 4 illustrates another view of a user interface for receiving a user query and providing suggestions to the user for replacements of elements of the query;

FIG. 5 illustrates a data store and client device connected to the data store, where the data store provides replacement suggestions that can be displayed at the client; and

FIG. 6 illustrates a method of suggesting replacements for search sub-strings of a query string to a user.

### DETAILED DESCRIPTION

Some embodiments may provide a structured approach for viewing and selecting suggestions of relevant and valid alternate sub-strings already input by a user in a search string. For example, if the user has typed “In the state of Washington what are the largest cities by” rather than simply offering suggestions of logical words to complete the utterance (such as in this example “population” or “area”), embodiments may offer alternate words that could have been used earlier in the search string to replace terms or sets of terms already entered by the user. For instance, in the example above, “Idaho”, “Montana”, “Alaska”, or other states could have been logically suggested as replacements for “Washington”. Similarly “smallest” or “average” could have been suggested as a replacement for “largest”. Further, the search engine could generate this list of replacements based on known available data so that only “valid”, quality result yielding suggestions are offered. This would allow the user to alter their search to other known-valid searches without prior knowledge of potential alternatives and assist the user with a subtle exploration of available data without the user needing to formulate new queries out of whole cloth. Thus, some embodiments do not simply rely on what previous users have searched for, but rather provide suggestions based on knowledge about what data an underlying data store actually has available.

When conducting a search using common user experiences for search, a user's search query string may contain one or more sub-strings that match instance values within, or elements of, a structured artifact containing information related to the search query string. For instance, in the search query string “List of Top Selling Rock Songs” “Rock” could be instance value within of a genre column of a “Songs” table in a music database. Some embodiments described herein implement a structured approach to provide a list of valid replacements for sub-strings (such as for example, one or more search terms) within a search query string based on determining “peers” or semantically valid replacements of the sub-strings matching instance values or other elements within a structured artifact. For example, an embodiment may provide the suggestions to replace “Rock” with one or more other instances in the genre column of the “Songs” table such as “Country” or “Pop”. This would be based on the fact that “Rock”, “Country” and “Pop” may appear in the same genre column and would thus be semantically equivalent. Thus, embodiments may suggest (by, for example, sending suggestions to a graphical user interface allowing a user to select) from the search string “List of Top Selling Rock Songs” any of the following semantically valid replacement queries:

“List of Top Selling Country Songs”

“List of Top Selling Pop Songs”

FIG. 1 illustrates a user interface 100 showing a user entered query string 102 and displayed alternative queries 104 from which a user could select.

Embodiments may provide suggestions to replace the search term “Songs” in the query string with sub-strings for other tables with a similar relationship to genres within the music database such as an “Albums” table or an “Artists” table. Thus, embodiments may suggest (by, for example, sending suggestions to a graphical user interface allowing a user to select) from the search string “List of Top Selling Rock Songs” any of the following semantically valid replacement queries:

“List of Top Selling Rock Albums”

“List of Top Selling Rock Artists”

FIG. 2 illustrates a user interface 200 showing a user entered query string 202 and displayed alternative queries 204 from which a user could select.

Further, “List of” and “Top” can be recognized as modifiers of the results and “peers” to these result modifiers can also be suggested. For example, systems may recognize that results can be presented in list form, table form, chart form, etc. Thus, embodiments could provide the following suggestions for the query string “List of Top Selling Rock Songs”:

“Table of Top Selling Rock Songs”

“Bar Chart of Top Selling Rock Songs”

FIG. 3 illustrates a user interface 300 showing a user entered query string 302 and displayed alternative queries 304 from which a user could select.

Further, “Bottom” could be substituted for “Top” in suggested queries. Thus, embodiments could provide the following suggestion for the query string “List of Top Selling Rock Songs”:

“List of Bottom Selling Rock Songs”

FIG. 4 illustrates a user interface 400 showing a user entered query string 402 and displayed alternative queries 404 from which a user could select.

Embodiments may include a user interface approach for viewing and selecting alternatives in a manner that can be integrated within existing common search experiences. For example, embodiments may include functionality for a user to view and be able to select, “peers” to recognized instance values or elements from a structured artifact within a common search experience helps the user explore available data and discover new search sub-strings more quickly. For example, a basic user experience to leverage this capability may display the list of valid replacements for any element of a search string in a drop down box (e.g. 108, 208, 308 or 408) displayed below the search box (e.g. 106, 206, 306, or 406) when the user has placed the cursor (110, 210, 310, or 410) within the text of an element.

Note that embodiments may be configured such that placement of the cursor affects what alternative query string elements are displayed. For example, in FIG. 1, the cursor 110 being placed at or in the term “Rock” results in the alternative sub-strings “Country” and “Pop” being displayed within alternative queries. In FIG. 2, the cursor 210 being placed at or in the term “Songs” results in the alternative sub-strings “Albums” and “Artists” being displayed within alternative queries. Similar examples are illustrated in FIGS. 3 and 4.

The following illustrates an algorithm for generating alternate valid-term suggestions for a sub-stings within a search query string. In particular, the following example is used to help illustrate additional details:

Consider the search string “Population of cities in Washington State” being issued to a search engine with access to a structured artifact, such as a database, containing the following database tables:

TABLE
“Cities”

| City | State | Population | Elevation | Average Income |
|---|---|---|---|---|
| Moscow | Idaho | xxx,xxx | xxx | xx,xxx |
| Pullman | Washington | xxx,xxx | xxx | xx,xxx |
| . . . | . . . | . . . | . . . | . . . |

TABLE
“Counties”

| City | State | Population | County Seat | Area |
|---|---|---|---|---|
| Latah | Idaho | xxx,xxx | Moscow | xx,xxx |
| Whitman | Washington | xxx,xxx | Colfax | xx,xxx |
| . . . | . . . | . . . | . . . | . . . |

The search experience could offer to the user suggestions for the “valid” replacements of peer elements based on the component or instance that matches different sub-strings within the search query string. For example, if a search string contains a sub-string, where the sub-string is similar or equivalent to the label of a column of a table, peer column labels may be suggested as alternative sub-strings. Thus for example, in the above tables, “City” appears as a column label of the “Counties” table, and thus “states”, “populations”, “county seats” or “areas”, or combinations thereof, may be presented as alternative search sub-strings to “cities” in the search string “Population of cities in Washington State”. Note that optimization may be performed to eliminate some alternatives based on their not being contextually valid or for other reasons. For example, in the above example, it does not make sense to replace “cities” with “populations” as that would result in the suggested search string “Population of populations in Washington State”. Further as will be explained below, algorithms may be used to select a set of the more relevant suggestions from among the set of all possible suggestions, as providing all possible suggestions could become unwieldy.

Similar functionality may be provided with respect to peer tables. For example, in the above example, one table is labeled “Cities” while the other table is labeled “Counties”. Thus, by substituting peer table labels where appropriate, the search string “Population of cities in Washington State” causes the system to yield the suggested search string “Population of counties in Washington State”

Similar functionality may be provided with respect to instance values in the search string. For example, in both the “Cities” table and the “Counties” table, “Idaho” is a peer instance value to “Washington”. Thus, “Idaho” might be a suggested sub-string that could be substituted for “Washington. Thus, by substituting peer instance values where appropriate, the search string “Population of cities in Washington State” causes the system to yield the suggested search string “Population of cities in Idaho State”

Embodiments can apply these principles to additional types of elements in a structured artifact such as measures in a multi-dimensional model. Any elements in a structured object where instances of “peer” elements can be determined are similarly applicable.

Recognized sub-strings that represent result modifiers are also matched, in some embodiments, within the search query string and peer result modifiers are suggested. This sub-string recognition/categorization could also be extended further for other classes of sub-strings.

For example, consider the query string: “Show Population of cities in Washington State sorted biggest to smallest as a bar chart”.

In this example: “as a bar chart” is a recognized output type and can be replaced with other recognized output types such as “as a line chart”, “as a table”, “as a list”, or other recognized output types.

In some embodiments, the recognized output types may be controlled by a user, where in other embodiments, the recognized output types may be controlled by a data store. For example, FIG. 5 illustrates a data store 502 connected to a user computing system 504. In some embodiments, the data store 502 may have a limited set of output types that it can provide, and thus can provide those as suggested sub-strings when a known output type is recognized from a query string input by a user at the user computing system 504, such that the data store 502 can then send the suggested replacements 506, which can then be displayed to the user at an interface (such as the interface 100) to the user.

Alternatively, the user computing system 504 may only be able to support certain output types which can be indicated, as illustrated at 508, to the data store 502. The data store 502 then sends the suggested replacements 506 to the user computing system when the data store 502 detects a known output type from a query string input by a user at the user computing system 504.

In yet another alternative embodiment, when the user computing system 504 knows the supported output types, the user computing system 504 can substitute in suggested replacement when the user computing system detects a known output type from a query string input by a user at the user computing system 504.

Note that the data store 502 and user computing system 504 may be implemented in a number of different ways, including where the two are remote from each other and/or implemented by different entities. Alternatively, the two may be part of a unified system. Other configurations may alternatively be implemented.

In another example, a query string may include the sub-string “sorted biggest to smallest”, which is a recognized command to control output display and can have as suggested replacements corresponding commands such as “sorted smallest to biggest” or other appropriate sub-strings.

In a generic context (outside of search) various commands may be recognized and replaced with similar types of commands. For example, the sub-string “show” might be recognized as command and suggested replacements of other available commands such as “copy” or “print” could be provided.

The following now illustrates details of how some embodiments determine some peer sub-strings or terms.

For a structured artifact, such as a tabular model, rules are used identify meaningful peers of each entity instance.

In the case of a tabular model, example rules utilized may include among other things:

| Entity | Peer |
|---|---|
| Table | Other tables in the model |
| Measure | Other measures in the |
| | model |
| Column | Other columns within the |
| | same table |
| Column Value | Other values in the |
| | column |

Additional rules to provide pre-defined lists of alternate stings to specific match sub-strings may be included. In the case of output display commands a list of inter-replaceable sub-strings may be provided. For example, visualization preferences that may be defined as peers may include “as line chart”, “as bar chart”, “as column chart”, “as scatter plot”, “as map”, etc. Note that embodiments may include functionality for determining sub-string peers based on synonyms of sub-strings or terms or other variations of substrings (such as plural and singular forms, gerund forms of verbs, and so forth).

Embodiments may include measurements as peers. For example, a set of peers may include: “distance”, “height”, “weight”, “speed”, “force”, “luminosity” “pressure”, “volume”, “power”, “flow”, etc.

Embodiments may include units as peers. For example, a set of peers may include: “inches”, “feet”, “miles”, “centimeters”, “pounds”, “grams”, etc.

Embodiments may include operators as peers. For example, mathematical and/or logical operators may be peers. Such operators may include addition, subtraction, multiplication, division, average, total, mean, OR, AND, XOR, etc.

Embodiments may include sources of data as peers. For example, if results are able to be obtained from multiple different databases, and a user query string identifies one of those databases, embodiments may be able to suggest other “peer” databases. For example, if the user query string included the phrase “from the Nasdaq”, peer data sources may be “Dow Jones Industrials” and “S&P 500”.

Note that in the preceding examples, only limited examples of peers have been illustrated and those of skill in the art will recognize that the sets could be greatly expanded, and that indeed other sets may be implemented.

The following now illustrates details with respect to one example of relevancy improvement. While simple peer-selection may be sufficient, relevancy of suggested alternatives can be improved by heuristically sorting (and optionally pruning) the selected peers in a number of ways. For example, some embodiments minimize relationship distance between the original object (i.e. original query sub-string) and the peer object (i.e. a suggested query sub-string). For example, when looking for an alternative for “city” in “total sales by city”, there exists direct relationships from “city” to “country” and from “city” to “customer”, whereas there is only an indirect relationship between “city” and “product” (e.g. via shipments). Therefore, “country” and “customer” are better suggested replacements for “city” than “product”.

Embodiments may implement semantic interpretation scoring to improve suggested sub-string replacements. For example, when looking for an alternative for the sub-string “city” in the query string “how many customers live in each city?”, evaluating each of the candidate alternatives (country, customer, and product) reveals that only one (country) results in a good query string, as customers do not live in customers and customers do not live in products (except perhaps in some limited circumstances, such as for example when the products are motor homes or other such products). Thus, embodiments can eliminate semantically valid replacements that are contextually invalid.

The following additional general principles may be applied to various embodiments:

Embodiments may include an interpretation result containing typical auto-complete and query string suggestions as well as peer-based sub-string replacement suggestions.

A completed utterance represents the utterance (search query string) that was interpreted. This is represented as a list of sub-strings.

Whitespace/word separation, in some embodiments, may be considered a term so that the client does not have to worry about adding whitespace as that may be different per language.

Alternate completions may be represented as a list of items where each item represents a substitution for a series of contiguous sub-strings.

For an alternate completion obtained from a query string log for example the substituted sub-strings will be all of them.

Term suggestions will provide a list of suggestions for term-replacements in the completed utterance terms.

public class InterpretationResult
{

public ShowDataCommand Command { get; set; }
public CompletedUtterance CompletedUtterance { get; set; }
public List<AlternateCompletion> AlternateCompletions { get; set; }
public List<SuggestionItem> SuggestionItems { get; set; }

}

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

Referring now to FIG. 6, a method 600 is illustrated. The method 600 may be practiced in a computing environment and includes acts for suggesting replacements for search sub-strings to a user. The method 600 includes receiving a query string from a user including a plurality of search sub-strings in the query string (act 602). For example, as illustrated in FIG. 1, a query string 102 could be entered into a search box 106 of a user interface 100. This query string 102 could then be provided to a system, such as the data store 502 that is able to determine and provide semantically valid replacements of search sub-strings. Thus, the data store 502 receives the query string from the user. In other embodiments, a stand-alone system may receive the query string from the user.

The method further includes determining semantically valid replacements of one or more search sub-strings in the query string (act 604). For example, as illustrated above, “Country” and “Pop” are identified as replacements to “Rock”, “Albums” and “Artists” are identified as replacements to “Songs”, etc. This could be performed, for example, by the data store 502, or by another system.

The method 600 further includes suggesting to the user semantically valid replacements of one or more of the search sub-strings to allow the user to modify the original query string (act 606). For example, as illustrated in FIGS. 1-4 replacements are illustrated in alternative queries 104, 204, 304, and 404 in a drop down box 108, 208, 308, and 408 of a user interface 100, 200, 300, and 400. Suggesting to the user may include, in one example, the data store 502 providing the suggestions to the user computing system.

The method 600 may be practiced where determining semantically valid replacements comprises determining replacement search sub-strings for a new query string, based on available data known to exist, such that the new query string is known to have valid results. For example, by using “peer” columns, tables, or results that are known to exist, a sub-string replacement can be suggested that would create new search queries that would be known to have valid results based on the existence and function of the “peer” columns, tables, or results. For example, in the illustrated example above, replacing “Cities” with “Counties” to create a new search string “Population of counties in Washington State” would be known to have a result as it is known that both the “Cities” table and the “Counties” table have a “Population” column.

The method 600 may be practiced where suggesting to the user semantically valid replacements of one or more of the search sub-strings comprises suggesting a limited set of semantically closest replacements from a set of known replacements. For example, a set of replacements may be identified, some replacements may be more relevant than others. This can be determined by various algorithms, such as distance in a database, similarity of sub-strings, linguistic suitability or other factors.

Thus, the method 600 may further include determining a distance in a database of semantically valid replacements of one or more search sub-strings in the query string. Suggesting to the user semantically valid replacements may therefore, be performed based on distance in the database to suggest semantically valid replacements that are more relevant than other semantically valid replacements.

Thus, the method 600 may further include determining linguistic suitability of semantically valid replacements of one or more search sub-strings in the query string. Suggesting to the user semantically valid replacements, may therefore be performed based on linguistic suitability of semantically valid replacements of one or more search sub-strings in the query string. For example, replacement sub-strings may be determined by having the same tense, being the same part of speech, (e.g. verbs to verbs, nouns to nouns, etc.), etc.

The method 600 may further include eliminating semantically valid replacements that are contextually invalid. For example as illustrated above, when looking for an alternative for the sub-string “city” in the query string “how many customers live in each city?” semantically valid replacements that are contextually invalid can be eliminated from replacements suggested to a user.

The method 600 may be practiced where determining semantically valid replacements of one or more search sub-strings in the query string comprises identifying a sub-string of the query that corresponds to a label of a table or column and identifying a label of a related table or column as a semantically valid replacement. Examples of this are illustrated above using the “Cities” and “Counties” tables.

The method 600 may be practiced where determining semantically valid replacements of one or more search sub-strings in the query string comprises identifying a sub-string of the query that corresponds to an instance in a column of a table and identifying a different instance in the column as a semantically valid replacement. Examples of this are illustrated above using the “Cities” and “Counties” tables.

The method 600 may be practiced where determining semantically valid replacements of one or more search sub-strings in the query string comprises identifying a sub-string of the query that corresponds to a mathematical or logical operator and identifying a different mathematical or logical operator as a semantically valid replacement.

The method 600 may be practiced where determining semantically valid replacements of one or more search sub-strings in the query string comprises identifying a sub-string of the query that corresponds to a visualization preference and identifying a different visualization preference as a semantically valid replacement. As illustrated in the description of FIG. 5, in some embodiments, the different visualization preference is selected from a limited group of visualization preferences provided to a data store by a client machine.

The method 600 may be practiced where determining semantically valid replacements of one or more search sub-strings in the query string comprises identifying a sub-string of the query that corresponds to a measure and identifying a different measure as a semantically valid replacement.

The method 600 may further include, receiving user input proximate a sub-string in the query string, and wherein suggesting to the user semantically valid replacements of one or more of the search sub-strings is performed to suggest one or more replacements of the sub-string proximate the user input. For example as illustrated in FIGS. 1-4 the cursor 110, 210, 310, and 410 position determines what replacement sub-strings are suggested.

The method 600 may further include visually highlighting sub-strings in the query for which valid semantic replacements have been determined. For example, a system may determine, by the modalities described above, which sub-strings in a query string have suggested alternatives. These sub-strings may be highlighted, such as by underlining, bolding, italicization, coloring, or otherwise to indicate to a user that a user could interact with those sub-strings (such as by cursor placement or selection) and would be presented with alternate query sub-strings.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of suggesting replacements for search sub-strings to a user, the method comprising:
receiving a query string from a user including a plurality of search sub-strings in the query string;
determining semantically valid replacements of one or more search sub-strings in the query string; and
suggesting to the user semantically valid replacements of one or more of the search sub-strings to allow the user to modify the original query string.

2. The method of claim 1, wherein determining semantically valid replacements comprises determining replacement search sub-strings for a new query string, based on available data known to exist, such that the new query string is known to have valid results.

3. The method of claim 1, wherein suggesting to the user semantically valid replacements of one or more of the search sub-strings comprises suggesting a limited set of semantically closest replacements from a set of known replacements.

4. The method of claim 1 further comprising determining a distance in a database of semantically valid replacements of one or more search sub-strings in the query string, and wherein suggesting to the user semantically valid replacements is performed based on distance in the database to suggest semantically valid replacements that are more relevant than other semantically valid replacements.

5. The method of claim 1 further comprising determining linguistic suitability of semantically valid replacements of one or more search sub-strings in the query string, and wherein suggesting to the user semantically valid replacements is performed based on linguistic suitability of semantically valid replacements of one or more search sub-strings in the query string.

6. The method of claim 1, further comprising eliminating semantically valid replacements that are contextually invalid.

7. The method of claim 1, wherein determining semantically valid replacements of one or more search sub-strings in the query string comprises identifying a sub-string of the query that corresponds to a label of a table or column and identifying a label of a related table or column as a semantically valid replacement.

8. The method of claim 1, wherein determining semantically valid replacements of one or more search sub-strings in the query string comprises identifying a sub-string of the query that corresponds to an instance in a column of a table and identifying a different instance in the column as a semantically valid replacement.

9. The method of claim 1, wherein determining semantically valid replacements of one or more search sub-strings in the query string comprises identifying a sub-string of the query that corresponds to a mathematical or logical operator and identifying a different mathematical or logical operator as a semantically valid replacement.

10. The method of claim 1, wherein determining semantically valid replacements of one or more search sub-strings in the query string comprises identifying a sub-string of the query that corresponds to a visualization preference and identifying a different visualization preference as a semantically valid replacement.

11. The method of claim 10, wherein the different visualization preference is selected from a limited group of visualization preferences provided to a data store by a client machine.

12. The method of claim 1, wherein determining semantically valid replacements of one or more search sub-strings in the query string comprises identifying a sub-string of the query that corresponds to a measure and identifying a different measure as a semantically valid replacement.

13. The method of claim 1, further comprising, receiving user input proximate a sub-string in the query string, and wherein suggesting to the user semantically valid replacements of one or more of the search sub-strings is performed to suggest one or more replacements of the sub-string proximate the user input.

14. The method of claim 1, further comprising visually highlighting sub-strings in the query for which valid semantic replacements have been determined.

15. A computing system configured to provide replacements for search sub-strings of a query string to a user, the system comprising;
one or more processors; and
one or more computer readable media, wherein the one or more computer readable media comprise computer executable instructions that when executed by at least one of the one or more processors cause the system to perform the following:
receiving a query string from a user including a plurality of search sub-strings in the query string;
sending the query string to a data store;
receiving from the data store one or more semantically valid replacements of one or more search sub-strings in the query string; and
displaying to the user the semantically valid replacements of one or more of the search sub-strings to allow the user to modify the original query string.

16. The method of claim 15, wherein the semantically valid replacements of one or more of the search sub-strings comprise a limited set of semantically closest replacements from a set of known replacements.

17. The method of claim 15, wherein a sub-string of the query string corresponds to a label of a table or column and the semantically valid replacements correspond to labels of related tables or columns.

18. The method of claim 15, wherein a sub-string of the query string corresponds to an instance in a column and the semantically valid replacements correspond to other instances in the same column.

19. The method of claim 15 further comprising, sending to the data store an indication of output types supported, and wherein a sub-string of the query string corresponds to an output and the semantically valid replacements correspond to other outputs identified in the indication of outputs supported.

20. A computer readable medium comprising computer executable instructions that when executed by one or more processors cause the following to be performed;
receiving a query string from a user including a plurality of search sub-strings in the query string;
determining semantically valid replacements of one or more search sub-strings in the query string; and
suggesting to the user semantically valid replacements of one or more of the search sub-strings to allow the user to modify the original query string.
